(19) United States
(12) Patent Application Publication
(10) Pub. No.: US 2015/0113221 A1
(43) Pub. Date: Apr. 23, 2015

(54) HYBRID INPUT/OUTPUT WRITE OPERATIONS

(71) Applicants: Herbert Hum, Portland, OR (US); Chandra Joshi, Bangalore (IN); Rahul Pal, Bangalore (IN); Luke Chang, Aloha, OR (US)

(72) Inventors: Herbert Hum, Portland, OR (US); Chandra Joshi, Bangalore (IN); Rahul Pal, Bangalore (IN); Luke Chang, Aloha, OR (US)

(21) Appl. No.: 13/997,426

(22) PCT Filed: Mar. 15, 2013
(86) PCT No.: PCT/US2013/032423

§ 371 Date: Jun. 24, 2013

(51) Int. Cl. G06F 12/08

(52) U.S. Cl. CPC G06F 12/0871; G06F 12/0875; G06F 2212/452; G06F 2212/225
USPC 711/125

(57) ABSTRACT

A first processor receives a write request from an input/output (I/O) device connected to the first processor. The first processor determines whether the write request satisfies an allocating write criterion. Responsive to determining that the write request satisfies the allocating write criterion, the first processor writes data associated with the write request to a cache of the first processor.

Embodiments described herein generally relate to the field of processors, processing logic, microprocessors, and associated instruction set architecture.

In modern computer systems, it is common to have multiple processors. Additionally, processors of modern computer systems may have multiple cores. In addition, other system components such as various semiconductor devices, e.g., input output (I/O) devices, controllers, chipsets and so forth are also present in a typical system.

Multi-processor systems may perform either allocating writes or non-allocating writes for data from I/O devices. Whether a system will perform an allocating write or a non-allocating write is typically controlled by a basic input/output system (BIOS) and set when the system is started. The BIOS may place the system into an allocating write mode, in which all writes for data from I/O devices are allocating writes. Alternatively, the BIOS may place the system into a non-allocating write mode, in which all writes for the data from the I/O devices are non-allocating writes. Such rigidity with respect to the write mode may introduce inefficiencies. For example, there are some situations in which the allocating write mode may be more efficient, and there are other situations in which the non-allocating write mode may be more efficient.

### BRIEF DESCRIPTION OF THE DRAWINGS

FIG. 1 is a high level block diagram showing a multi-processor computing device.

FIG. 2 is a flow diagram of a method for performing I/O writes in accordance with one embodiment of the present invention.

FIG. 3 is a flow diagram of a method for performing I/O writes in accordance with another embodiment of the present invention.

FIG. 4 is a block diagram of a multi-core processor coupled to additional processors.

FIG. 5 is a block diagram of a computing device in accordance with an embodiment of the present invention.

### DESCRIPTION OF EMBODIMENTS

Described herein are various embodiments of a hybrid write mode, as well as a system and processor that implement a hybrid write mode. With the hybrid write mode enabled, a processor that receives a write request from an input/output (I/O) device may determine whether to perform an allocating write or a non-allocating write to satisfy the write request. This determination may be made dynamically (e.g., on-the-fly) based on properties of the write request and/or properties of a system incorporating the processor in order to maximize efficiency and reduce data access times.

For non-allocating writes, data associated with a write request is written to main memory. For allocating writes, data associated with the write request is written to a cache (e.g., a last level cache (LLC)) of a processor instead of into the main memory. In some instances, allocating writes introduce lower data access and lower power usage as compared to non-allocating writes. However, for multi-processor computing devices, the allocating writes may increase data access times in some instances. For example, if a first processor triggers a write request for an I/O device attached to a second processor, a non-allocating write would cause data to be written to main memory connected to the first processor. However, an allocating write in such a circumstance would cause the data to be written to the LLC of the second processor. In order for the first processor to access that data, the first processor would then initiate a cache-to-cache transfer to copy or move the data from the LLC of the second processor to an LLC of the first processor. This cache-to-cache transfer may introduce greater delay than reading the data from main memory.

In one embodiment, a first processor receives a write request from an input/output (I/O) device connected to the first processor. The first processor determines whether the write request satisfies an allocating write criterion. Responsive to determining that the write request satisfies the allocating write criterion, the first processor writes data associated with the write request to a cache of the first processor. Responsive to determining that the write request fails to satisfy the allocating write criterion, the first processor writes the data associated with the write request to a memory associated with (e.g., managed by) a second processor. Thus, the first processor may dynamically determine for each write request which of an allocating write operation and a non-allocating write operation is optimal, and then perform the optimal write operation.

In embodiments, use of a hybrid write mode may have an advantageous effect of minimizing data access times. For each write request, a processor may determine whether an allocating write or a non-allocating write will have lower data access times. The processor may then select the write mode with the lower data access time for the write requests. Additionally, the hybrid write mode may have an advantageous effect of conserving system resources, including system power and memory bandwidth. For example, writing to and reading from main memory may consume greater power than writing to and reading from a processor's cache. Accordingly, selection of an allocating write where appropriate may conserve power.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the described embodiments. It will be apparent, however, to one skilled in the art that these specific details need not be employed to practice the described embodiments. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring embodiments of the present invention.

Although the following embodiments are described with reference to a processor, other embodiments are applicable to other types of integrated circuits and logic devices. Similar techniques and teachings of embodiments of the present invention can be applied to other types of circuits or semiconductor devices that can benefit from higher pipeline throughput and improved performance. The teachings of embodiments of the present invention are applicable to any processor or machine that performs data manipulations. However, the present disclosure is not limited to processors or machines that perform 512 bit, 256 bit, 128 bit, 64 bit, 32 bit, or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present invention rather than to provide an exhaustive list of all possible implementations of embodiments of the present invention.

Although the below examples describe instruction handling and distribution in the context of execution units and logic circuits, other embodiments of the present invention can be accomplished by way of a data or instructions stored on a computer-readable, tangible medium, which when performed by a machine (e.g., a computing device) cause the machine to perform functions consistent with at least one embodiment of the invention. In one embodiment, functions associated with embodiments of the present invention are embodied in computer-readable instructions. The instructions can be used to cause a general-purpose or special-purpose processor that is programmed with the instructions to perform described operations. Embodiments of the present invention may be provided as a computer program product or software which may include a machine or computer-readable medium having stored thereon instructions which may be used to program a computer (or other electronic devices) to perform one or more operations described herein. Alternatively, operations of embodiments of the present invention might be performed by specific hardware components that contain fixed-function logic for performing the operations, or by any combination of programmed computer components and fixed-function hardware components.

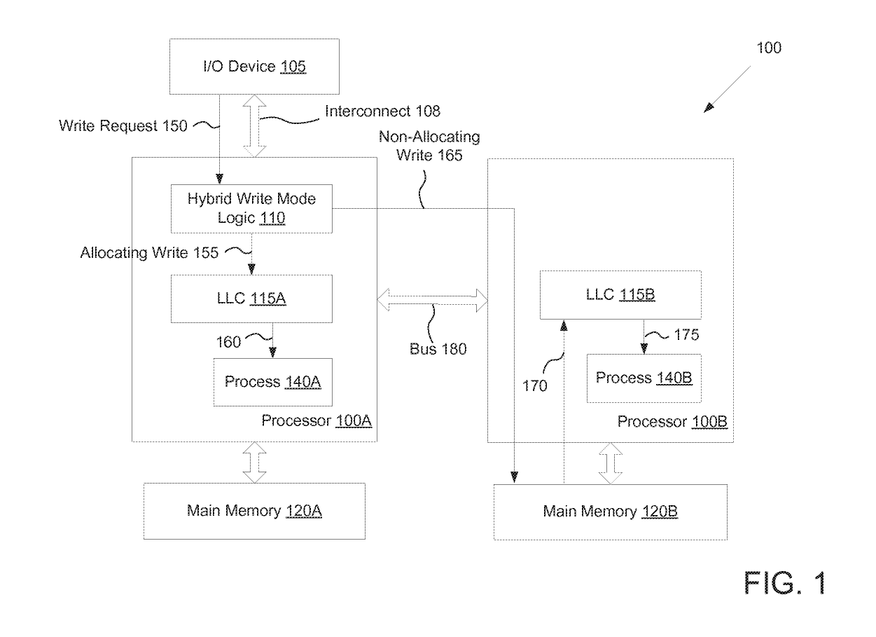

Referring now to FIG. 1, shown is a high level block diagram of a multi-processor computing device 100. The multi-processor computing device 100 may be a server computer (e.g., a rackmount server), a personal computer, a desktop computer, a laptop computer, a tablet computer, a mobile phone, a switch, a router, or other computing device. The multi-processor computing device 100 includes processor 102A and processor 102B (also referred to as a socket or processor socket) in accordance with an embodiment of the present invention. Processors 102A, 102B may be single-core or multi-core processors. The multi-processor computing device 100 may also include additional processors. However, two processors 102A, 102B are shown to clearly illustrate embodiments of the present invention. The processors 102A, 102B may be connected via a bus 180 such as a QuickPath Interconnect (QPI®).

The multi-core computing device 100 may additionally include an I/O device 105 connected (e.g., electrically coupled) to processor 102A. In one embodiment, the I/O device 105 is a peripheral component interconnect (PCI) device. I/O device 105 may be, for example, a network adapter (e.g., a network interface card (NIC)), a graphics card, an audio card, a small computer serial interface (SCSI) controller, a cluster interconnect, a hard drive controller, a disk drive, and so forth. Processor 102A may connect to the I/O device 105 via an interconnect 108. Interconnect 108 may be a PCI bus, a PCI express (PCIe) bus, PCI extended (PCI-X) bus, or other type of interconnect.

Processor 102A may receive a write request 150. In one embodiment, an integrated Input/Output cluster (IIO) of the first processor receives the write request from the I/O device 105. Alternatively, an external I/O hub associated with the processor 102A may receive the write request and forward it to processor 102A. In one embodiment, the write request is a PCI write request. The write request may be a local write request (e.g., for a local PCI write) that originates at processor 102A and that is associated with a cache line managed by the processor 102A. The write request may alternatively be a remote write request (e.g., for a remote PCI write) that originates at processor 102A and that is associated with a cache line managed by processor 102B. An I/O write to a cache line controlled by a remote processor (e.g., by processor 102B) is considered to be a remote write, while an I/O write to a cache line controlled by a local processor (e.g., by processor 102A) is considered to be a local write.

I/O write operations (e.g., PCI writes) may be used to bring blocks of data from disk (e.g., from hard disk drives or other secondary storage) into memory. Specifically, when data is to be read from a disk into memory, a stream of PCI write operations may be performed. In multi-processor systems, such streams of PCI writes may include remote PCI writes that originate from a first processor socket (e.g., processor 102A) and are associated with cache lines managed by a second processor socket (e.g., processor 102B). Such streams of PCI writes may also include local PCI writes that originate at the first processor and are associated with cache lines controlled by the first processor. Accordingly, optimizations associated with I/O write operations are desirable.

In one embodiment, a hybrid write mode logic 110 of the first processor 102A receives the write request 150. The hybrid write mode logic may be a component of an integrated input/output cluster (IIO), a component of a home agent, a component of a caching agent, or a standalone component of the processor 102A. The hybrid write mode logic 110 may receive the write request if a hybrid write mode has been enabled for the multi-processor computing device 100. The hybrid write mode may be exposed as a user selectable option via an interface for a basic input/output system (BIOS) of the computing device 100.

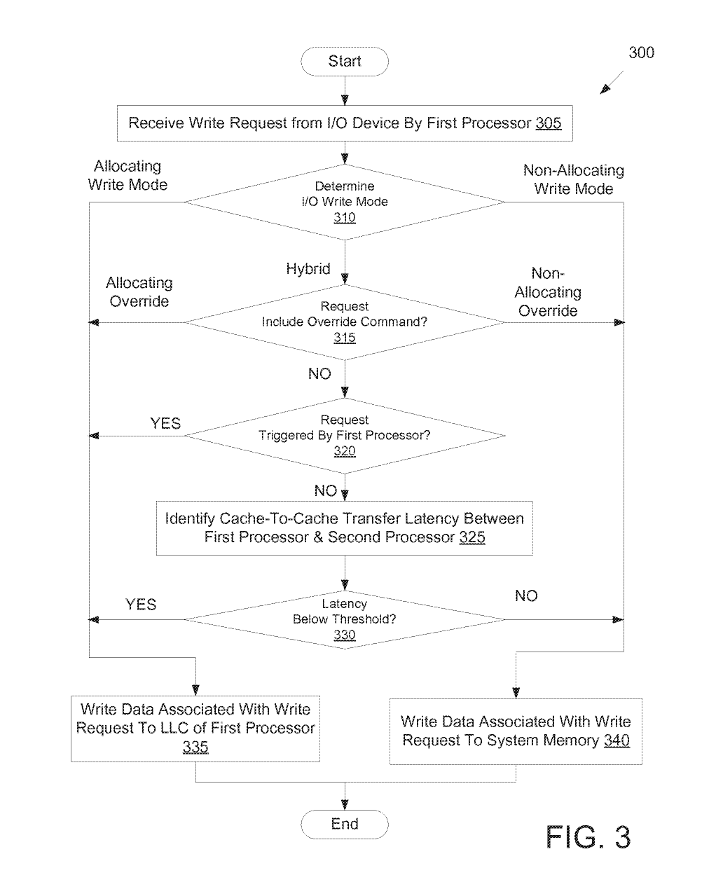

Hybrid write mode logic 110 analyzes the write request 150 to determine whether the write request 150 satisfies an allocating write criterion. For example, hybrid write mode logic 110 may analyze the write request 150 to determine whether the write request 150 was triggered by process 140A running on processor 102A or by process 140B running on processor 140B. An I/O write flow generally begins with a request for ownership of a cache line identified in the write request. If the write request identifies a cache line controlled by processor 102B, then hybrid write mode logic 110 may determine that the write request was triggered by process 140B. If the write request identifies a cache line controlled by processor 102A, then hybrid write mode logic 110 may determine that the write request was triggered by process 140A. Other allocating write criteria may also be used, as discussed in greater detail below with reference to FIG. 3.

If hybrid write mode logic 110 determines that the write request 150 satisfies the allocating write mode criterion, hybrid write mode logic 110 initiates an allocating write flow, and an allocating write 155 is performed. The allocating write 155 writes data associated with the write request (e.g., data included in the write request) into last level cache (LLC) 115A of processor 102A. However, in such an instance the data is not written into main memory 120A connected to processor 102A. Process 140A may retrieve 160 the data from LLC 115A and consume it without retrieving the data from main memory 120A. This may reduce power consumption, reduce memory traffic overhead and lower a data access time.

If hybrid write mode logic 110 determines that the write request 150 fails to satisfy the allocating write mode criterion, hybrid wrote mode logic 110 initiates a non-allocating write flow, and a non-allocating write 165 is performed. In one embodiment, the write request 150 fails to satisfy the allocating write criterion if the write request was triggered by a remote processor (e.g., by processor 102B). In a further embodiment, the write request 150 fails to satisfy the allocating write criterion if the write request was triggered by a remote processor that is over a threshold distance from processor 102A or that has greater than a threshold cache-to-cache transfer latency with processor 102A.

The non-allocating write 165 writes data associated with the write request 150 to main memory. In the illustrated example, the write request was triggered by process 140B and is a request to write data to a cache line controlled by processor 102B. Accordingly, the non-allocating write 165 writes the data to a cache line in main memory 120B connected to processor 102B. When process 140B is ready to use the data, process 140B may determine that a latest version of a cache line holding the data resides in main memory 120B and cause the cache line (and its data) to be written 170 into LLC 115B. Process 140B may then use the data in LLC 115B. Use of the non-allocating write for data owned by remote processors may reduce the use of coherency operations between processors. Additionally, the non-allocating write may introduce a lower latency than a latency associated with moving the data from LLC 115A to LLC 115B of processor 102B via a cache-to-cache transfer and then retrieving the data from LLC 115B.

The non-allocating write flow may be particularly useful in, for example, four socket computing devices. For example, in a four socket computing device arranged in a ring configuration, a first processor may be connected to a second processor, which may be connected to a third processor, which may be connected to a fourth processor, which may be connected back to the first processor. For data to travel from the first processor to the third processor, that data travels through the second and/or fourth processors. This can increase an amount of time used to complete operations such as cache-to-cache transfers between the first and third processors.

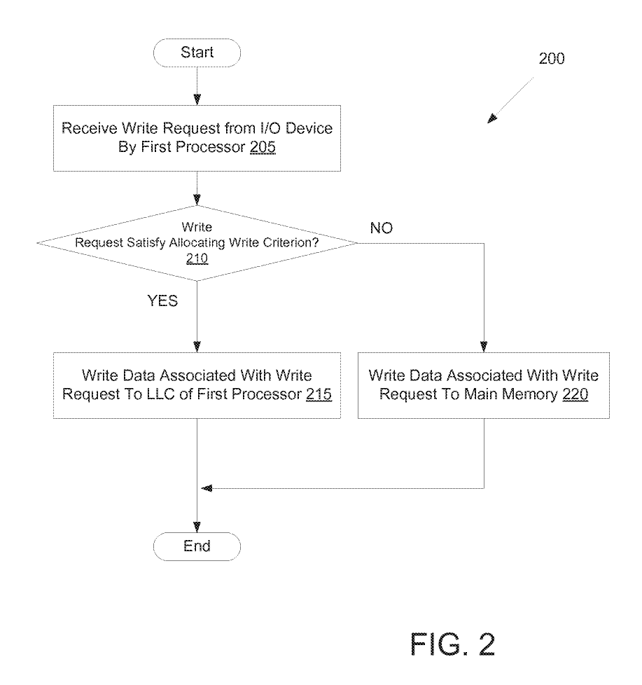

FIG. 2 is a flow diagram of a method 200 for performing I/O writes in accordance with one embodiment of the present invention. Method 200 may be implemented by processing logic of a processor, such as by a hybrid write mode logic in a processor. In one embodiment, various operations of method 200 are performed by a hybrid write mode logic 110 of FIG. 1.

At block 205 of method 200, processing logic of a first processor receives a write request from an I/O device. At block 210, processing logic determines whether the write request satisfies an allocating write criterion. In one embodiment, processing logic determines that a cache line indicated in the write request is managed by a remote processor. Processing logic may determine that such a write request fails to satisfy the allocating write criterion. If the write request satisfies the allocating write criterion, the method continues to block 215. If the write request fails to satisfy the allocating write criterion, the method proceeds to block 220.

At block 215, processing logic initiates an allocating write flow, and writes data associated with the write request into a cache (e.g., an LLC) of the first processor. This may include obtaining ownership of a cache line, adding the cache line into the LLC of the first processor 102A, and writing the data to the cache line in the LLC.

At block 220, processing logic initiates a non-allocating write flow, and writes data associated with the write request into main memory. This may include obtaining ownership of a cache line of main memory and writing the data into the cache line in main memory.

FIG. 3 is a flow diagram of a method 300 for performing I/O writes in accordance with another embodiment of the present invention. Method 300 may be implemented by processing logic of a processor, such as by a hybrid write mode logic in a processor. In one embodiment, various operations of method 300 are performed by a hybrid write mode logic 110 of FIG. 1.

At block 305 of method 300, processing logic of a first processor receives a write request from an I/O device. At block 310, processing logic determines whether an allocating write mode, a non-allocating write mode or a hybrid write mode is enabled. Such write modes may be enabled in a BIOS. For example, a user may select one of an allocating write mode, non-allocating write mode or hybrid write mode via a BIOS user interface. If an allocating write mode is enabled, the method proceeds to block 335. If a non-allocating write mode is enabled, the method proceeds to block 340. If a hybrid write mode is enabled, the method continues to block 315.

At block 315, processing logic determines whether the write request includes a write mode override command. A write mode override command may cause processing logic to perform an allocating write or a non-allocating write regardless of an enabled write mode. A write request may include a write mode override command if a process or thread that triggered the write request directed a device driver for the I/O device to satisfy a write request with either an allocating write or a non-allocating write.

Write requests may include an indicator that a particular write mode should be used to satisfy the write request. The indicator may be a bit or set of bits. For example, if a first bit in the write request is set, this may indicate that the write request should be satisfied by an allocating write. If a second bit in the write request is set, this may indicate that the write request should be satisfied by a non-allocating write. The I/O device driver may set the allocating write bit or non-allocating write bit when generating the write request. If an allocating write override command is received, the method proceeds to block 335. If a non-allocating write override command is received, the method proceeds to block 340. If no override commands are received, the method continues to block 320. Note that in the illustrated embodiment, write requests are not checked for override commands if the allocating write mode or non-allocating write modes are enabled. However, write requests may also be checked for override commands in these instances.

At block 320, processing logic determines whether the write request was triggered by the first processor or by a remote second processor. The write request may specify a particular cache line that data in the write request is to be written to. The particular cache line may be controlled by the first processor or by the second processor. If the cache line is controlled by the first processor, processing logic may determine that the write request was triggered by a process or thread running on the first processor. If the cache line is controlled by the second processor, processing logic may determine that the write request was triggered by a process or thread running on the second processor. If the write request was triggered by the first processor, the method proceeds to block 335. If the write request was triggered by a remote processor, the method continues to block 325.

At block 325, processing logic identifies a cache-to-cache transfer latency between the first processor and the second processor. This latency value may have been previously determined at startup, and may have been recorded. For example, when a computing device starts up, processors of that computing device may detect neighboring processors, and may perform sample transactions (e.g., sample cache-to-cache transfer transactions) with those neighboring processors. Latency values for such sample transactions may be recorded. In such an instance, determining the cache-to-cache transfer latency may include reading a previously recorded latency value.

In configurations of some multi-processor computing devices, not all processors are directly connected to one another. For example, in a ring configuration, a first processor may be connected to a second processor indirectly via one or more intermediate processors. The separation between two processors may impact the cache-to-cache transfer latency between those processors. For example, a latency of about 18-20 nanoseconds may be introduced for a single communication between adjacent (e.g., directly connected) processors. Therefore, round trip communication between adjacent processors may have a latency of about 40 nanoseconds, and round trip communication between processors that are separated by one intervening processor may have a latency of about 80 nanoseconds.

At block 330, processing logic determines whether the cache-to-cache transfer latency is below a latency threshold. In one embodiment, the latency threshold is approximately 60 nanoseconds. Accordingly, if the latency is below 60 nanoseconds, an allocating write criterion may be satisfied. If the latency is below the threshold, the method proceeds to block 335. Otherwise, the method continues to block 340.

Rather than (or in addition to) using actual latency values as an allocating write criterion, processing logic may use a separation between processors as an allocating write criterion. Accordingly, processing logic may determine a quantity of processors separating the first processor and the second processor. In one implementation, if the second processor is directly connected to the first processor (not separated by any intervening processors), then the latency of performing a cache-to-cache transfer may be around or below a latency introduced by writing data to and reading data from main memory. However, if the second processor is separated from the second processor by one or more intervening processors, than the latency for performing the cache-to-cache transfer may be above the latency introduced by writing data to and reading data from main memory. Accordingly, if there are fewer than a threshold quantity of processors between the first processor and the second processor, then at block 330 the method may continue to block 335. If there are at least the threshold quantity of separating processors (e.g., one or more intervening processors in one implementation), then the method may continue to block 340.

At block 335, processing logic performs an allocating write. Accordingly, processing logic writes data associated with the write request to a last level cache of the first processor.

At block 340, processing logic performs a non-allocating write. Accordingly, processing logic writes data associated with the write request to main memory controlled by the second processor.

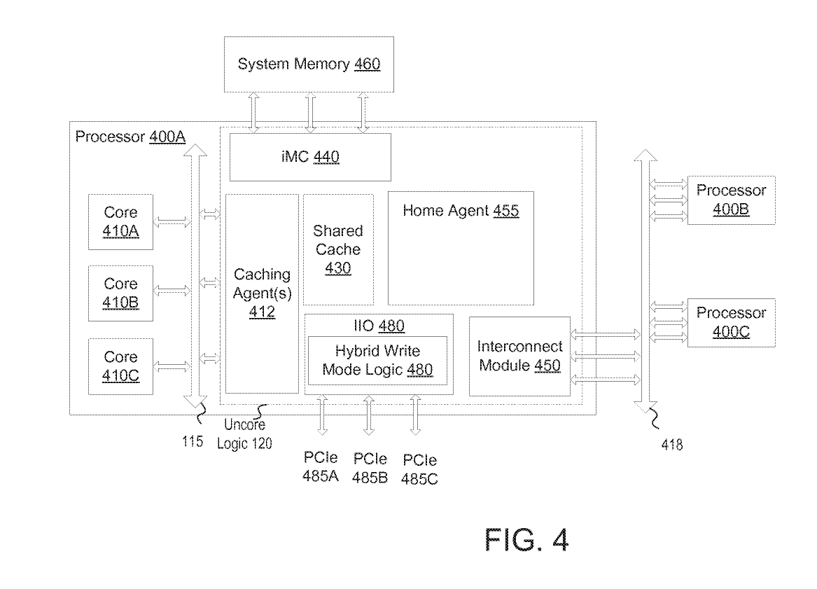

Referring now to FIG. 4, shown is a high level block diagram of a processor 400A in accordance with an embodiment of the present invention. In one embodiment, processor 400A corresponds to processor 102A of FIG. 1. As shown in FIG. 4, processor 400A may be a multicore processor including multiple cores 410A-410C. These cores may be physical processors, and may include various components such as front end units, execution units and back end units.

The various cores may be coupled via an interconnect 415 to an uncore logic 420. The uncore logic 420 is logic of the processor 410A outside of the cores that includes various components. Uncore logic 420 may include a shared cache 430 which may be a last level cache (LLC). In addition, the uncore logic 420 may include an integrated memory controller (iMC) 440, a home agent (HA) 455, one or more caching agents (referred to as Cbos) 412, an integrated input/output cluster (IIO) 480, and an interconnect module 450 that connects the processor 400A to other processors 400B, 400C via an interconnection 418.

One or more caching agents 412 (Cbos) manage the interface 415 between the cores 410A-C and the shared cache 430. Thus, caching agents 412 write data to and read data from cache lines in shared cache 430. The caching agents 412 are responsible for managing data delivery between the cores 410A-C and the shared cache 412. The caching agents 412 are also responsible for maintaining cache coherency between the cores 410A-C within a single socket (e.g., within processor 400A). This may include generating snoops and collecting snoop responses from cores 410A-C in accordance with a cache coherence protocol such as MESI, MOSI, MOESI, or MESIF. The uncore logic 420 may include multiple caching agents 412 (e.g., 8 caching agents in one embodiment), each assigned to manage a distinct subset of the shared cache.

The caching agents 412 may act as a proxy between the IIO 480 and the interconnect module 450, which in one embodiment is a QuickPath Interconnect (QPI). Thus, the caching agents 412 perform a gate keeper function for all messages that originate from the IIO 480 and that are to be transmitted to remote sockets (e.g., processors 400B-C). Similarly, the caching agents 412 may act as a proxy for messages originating in the remote sockets and associated with a cache line that is owned by an I/O device that IIO 480 communicates with.

Integrated input/output cluster (IIO) 480 is an I/O controller that is included in processor 400A. In alternative embodiments an external input/output controller (e.g., an I/O controller hub, which may be a component of a southbridge integrated circuit) may be used rather than IIO 480. IIO 480 (or other I/O controller) connects to and controls I/O devices. For example, IIO 480 may connect to I/O devices via PCI, PCI express (PCIe), PCI extended (PCI-X), or other buses 485A-C. The I/O devices may be, for example, network adapters, graphics cards, audio cards, SCSI controllers, cluster interconnects, hard drive controllers, disk drives, and so forth.

The IIO 480 may receive I/O write requests (e.g., for PCIe writes) from I/O devices connected to the IIO. In one embodiment, IIO 480 includes a hybrid write mode logic 480 that controls whether to satisfy a write request by performing an allocating write or a non-allocating write. Alternatively, the hybrid write mode logic 480 may be a component of the home agent 455 or caching agent 412. The hybrid write mode logic 480 may perform, for example, the operations of methods 300 and/or 400 responsive to a write request from I/O devices connected to any of PCIe 485A, PCIe 485B or PCIe 485C.

The flow for an allocating write and the flow for a non-allocating write may both begin with an initial ownership request, but differ in the way that a subsequent writeback is performed. Both the allocating write flow and non-allocating write flow generally begins with a request for ownership of a cache line from a caching agent attempting to perform the write. The ownership request for the cache line (or multiple cache lines) is sent to a local home agent 455 or a remote home agent that manages the cache line. An ownership request is a request for exclusive access to a cache line. Since the originating I/O device typically has no intention of reading the cache line's preexisting data, this flow may not include a read of the data at the cache line. Accordingly, an invalidate to exclusive (InvItoE) command may be issued by the caching agent 412 to the managing home agent of the cache line to obtain ownership of the line without obtaining data in the line. Alternatively, a read invalidate own (RdInvOwn) command may be issued in the case that the I/O device is to read existing data from the cache line.

The InvItoE or RdInvOwn command may be followed by a write of new data to the cache line (a writeback). For the non-allocating flow, the I/O write may be sent to the home agent in the form of a modified to invalid (WbMtoI) command because the data will not be cached in that processor's shared cache. The WbMtoI command is a command to write a cache line in a modified state back to memory, and transition its state in the issuing caching agent to invalid (I). For the allocating flow, the data may be cached in the shared cache in a modified (M) state, and may be subsequently sent to the home agent via a modified to exclusive (WbMtoE) command. The WbMtoE command is a command to write a cache line in an M state back to memory, and transition its state to exclusive (E).

Home agent 455 controls coherent access to, and otherwise manages, a subset of a system memory 460. Home agents are responsible for ensuring that a most recent version of data is returned to a requestor either from memory or a cache. The home agents are also responsible for invalidating cache lines associated with caching agents responsive to requests for exclusive access to the data. For example, home agent 455 may perform various processing for requests directed to a portion of system memory 460 coupled to processors 400A-C. This region of system memory (e.g., a range of memory addresses and/or cache lines) may, for example, correspond to one or more dual in-line memory modules (DIMMs). More specifically, home agent 455 may receive incoming requests that are directed to this region of memory and, via logic present in the home agent 455, resolve conflicts and maintain ordering of transactions among other operations. Accordingly, home agent 455 may include logic to receive requests from various components or agents (e.g., caching agents 412 from any of processors 400A-C) and route these requests as appropriate to the corresponding region of memory via integrated memory controller (iMC) 440 (or through an external memory controller).

Integrated memory controller 440 is the interface between system memory (e.g., DRAM) 460 and the home agent 455. Accordingly, integrated memory controller 440 translates read and write commands into specific memory commands and schedules them with respect to memory timing.

Note that each processor 400A, 400B, 400C may include its own home agent, and each home agent may be responsible for managing a different region of shared memory 460. Each processor 400A, 400B, 400C may additionally be a multi-core processor that includes an uncore logic such as uncore logic 420. Accordingly, each processor 400A-400C may be connected to different I/O devices, and may manage a different region of system memory 460. The home agents of the processors 400A-C may use a cache coherency protocol such as MESIF, MESI, etc. to maintain coherent caches of system memory 460.

The IIO 480 may include an input/output (I/O) write cache. After the IIO 480 receives a write request from an I/O device (e.g., a PCI write request), IIO 480 may add an entry to the I/O write cache for a specific cache line once ownership of the cache line is received. If the write request is associated with a cache line that is managed by a home agent of a remote socket (e.g., processor 400B or 400C), IIO 480 may add an identifier to the entry indicating this fact. The indicator in the entry may be used by hybrid write mode logic 480 to determine whether to initiate an allocating write flow or a non-allocating write flow.

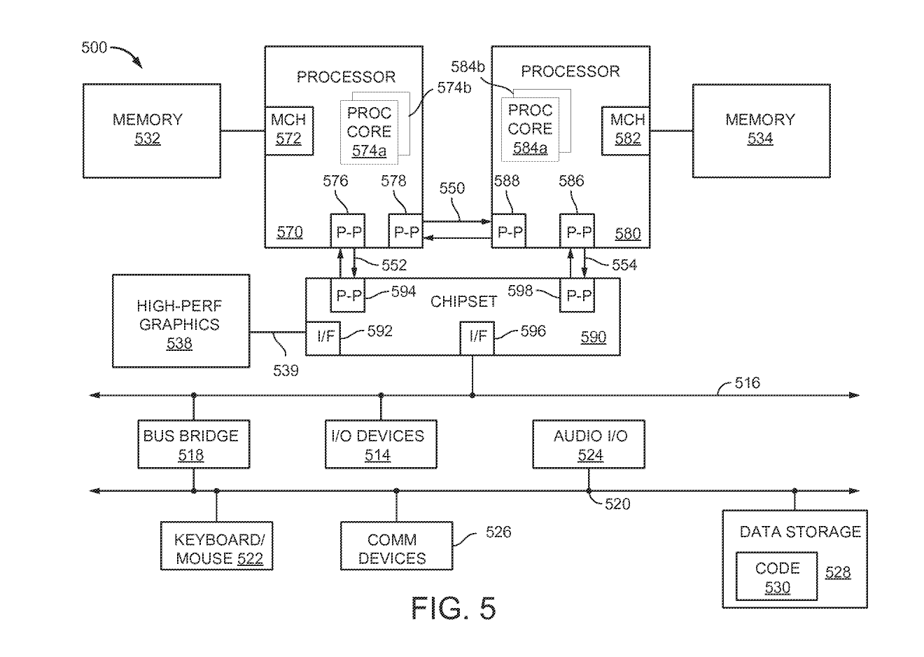

Embodiments may be implemented in many different system types. Referring now to FIG. 5, shown is a block diagram of a system in accordance with an embodiment of the present invention. As shown in FIG. 5, multiprocessor system 500 is a point-to-point interconnect system, and includes a first processor 570 and a second processor 580 coupled via a point-to-point interconnect 550. As shown in FIG. 5, each of processors 570 and 580 may be multicore processors, including first and second processor cores (i.e., processor cores 574a and 574b and processor cores 584a and 584b), although potentially many more cores may be present in the processors. The processors each may include hybrid write mode logics in accordance with an embodiment of the present.

Still referring to FIG. 5, first processor 570 further includes a memory controller hub (MCH) 572 (e.g., an integrated memory controller) and point-to-point (P-P) interfaces 576 and 578. Similarly, second processor 580 includes a MCH 582 and P-P interfaces 586 and 588. MCH's 572 and 582 couple the processors to respective memories, namely a memory 532 and a memory 534, which may be portions of main memory (e.g., a dynamic random access memory (DRAM)) locally attached to the respective processors, and which collectively may maintain a directory. First processor 570 and second processor 580 may be coupled to chipset 590 via P-P interconnects 552 and 554, respectively.

Chipset 590 includes P-P interfaces 594 and 598. Furthermore, chipset 590 includes an interface 592 to couple chipset 590 with a high performance graphics engine 538, by a P-P interconnect 539. In turn, chipset 590 may be coupled to a first bus 516 via an interface 596. Various input/output (I/O) devices 514 (also referred to as I/O devices) may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of non-transitory storage medium such as disk including floppy disks, optical disks, hard disks/magnetic disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

The following examples pertain to further embodiments. Example 1 is a processor having a cache and a hybrid write mode logic coupled to the cache. The hybrid write mode logic is configured to receive a write request from an input/output (I/O) device connected to the processor, determine whether the write request satisfies an allocating write criterion, and write data associated with the write request to the cache of the processor responsive to determining that the write request satisfies the allocating write criterion.

In example 2, the hybrid write mode logic of example 1 may further be configured to write the data associated with the write request to a memory associated with a second processor responsive to determining that the write request fails to satisfy the allocating write criterion. In example 3, determining whether the write request satisfies the allocating write criterion comprises determining whether the write request was triggered by a process running on the processor, wherein the write request satisfies the allocating write criterion if the write request was triggered by a process running on the processor. Example 3 may optionally extend the subject matter of any one of examples 1 and 2. In example 4, the hybrid write mode logic is further configured to determine a latency associated with cache to cache transfers between the processor and an additional processor executing a process that triggered the write request. Additionally, in example 4, determining whether the write request satisfies the allocating write criterion comprises determining whether the latency is below a latency threshold, wherein the write request satisfies the allocating write criterion if the latency is below the latency threshold. Example 4 may optionally extend the subject matter of any one of examples 1-3.

In example 5, the processor of any one of examples 1-4 is one of a plurality of processors arranged in a ring configuration. In example 5, the hybrid write mode logic is further configured to determine a quantity of the plurality of processors separating the processor and an additional processor. In example 5, determining whether the write request satisfies the allocating write criterion comprises determining whether the quantity of the plurality of processors separating the processor and the additional processor is below a threshold, wherein the write request satisfies the allocating write criterion if the quantity is below the threshold.

In example 6, which may optionally supplement the subject matter of any one of examples 1-5, determining whether the write request satisfies the allocating write criterion comprises determining whether the write request includes an indicator that the write request is to be satisfied with an allocating write, wherein the write request satisfies the allocating write criterion if the indicator is detected. In example 7, which may optionally supplement the subject matter of example 6, the indicator is a set bit in the write request, wherein the I/O device sets the bit in the write request responsive to a process running on one of the processor or an additional processor sending an instruction to a driver for the I/O device that the write request is to be satisfied by the allocating write. In example 8, a computing device comprises a plurality of processors, wherein one of the plurality of processors corresponds to the processor of any one of examples 1-7.

In example 9, a method of performing a write operation comprises receiving, by a first processor, a write request from an input/output (I/O) device connected to the first processor. The method further comprises determining, by the first processor, whether the write request satisfies an allocating write criterion. The method further comprises responsive to determining that the write request satisfies the allocating write criterion, writing data associated with the write request to a cache of the first processor. In example 10, the subject matter of example 9 may include, responsive to determining that the write request fails to satisfy the allocating write criterion, writing the data associated with the write request to a memory associated with a second processor. In example 11, the subject matter of any one of examples 9-10 may include determining whether the write request satisfies the allocating write criterion based on determining whether the write request was triggered by a process running on the first processor, wherein the write request satisfies the allocating write criterion if the write request was triggered by a process running on the first processor.

In example 12, the subject matter of any one of examples 9-11 may include determining a latency associated with cache to cache transfers between the first processor and a second processor executing a process that triggered the write request, wherein determining whether the write request satisfies the allocating write criterion comprises determining whether the latency is below a latency threshold, and wherein the write request satisfies the allocating write criterion if the latency is below the latency threshold. In example 13, the subject matter of any one of examples 9-12 may include a plurality of processors arranged in a ring configuration, wherein the method further comprises determining a quantity of the plurality of processors separating the first processor and the second processor, wherein determining whether the write request satisfies the allocating write criterion comprises determining whether the quantity of the plurality of processors separating the first processor and the second processor is below a threshold, and wherein the write request satisfies the allocating write criterion if the quantity is below the threshold.

In example 14, the subject matter of any one of examples 9-13 may include determining whether the write request satisfies the allocating write criterion based on determining whether the write request includes an indicator that the write request is to be satisfied with an allocating write, wherein the write request satisfies the allocating write criterion if the indicator is detected. In example 15, the subject matter of example 14 may be implemented, wherein the indicator is a set bit in the write request, and wherein the I/O device sets the bit in the write request responsive to a process running on one of the first processor or a second processor sending an instruction to a driver for the I/O device that the write request is to be satisfied by the allocating write.

In examples 16, at least one computer readable medium comprises instructions that, when executed by a computing device, cause the computing device to carry out a method according to any one of examples 9-15. In example 17, an apparatus comprises means for performing the method of any one of examples 9-15. In example 18, an apparatus comprises a processor configured to perform the method of any one of examples 9-15.

In example 19, a multi-processor computing device comprises an input/output (I/O) device and a plurality of processors interconnected via a bus, the plurality of processors comprising a first processor that is connected to the I/O device. The first processor of example 19 is configured to receive a write request from the I/O device, determine whether the write request satisfies an allocating write criterion, write data associated with the write request to the cache of the processor responsive to determining that the write request satisfies the allocating write criterion. In example 20, the subject matter of example 19 may include the first processor being further configured to write the data associated with the write request to a memory associated with a second processor responsive to determining that the write request fails to satisfy the allocating write criterion.

In example 21, the subject matter of any one of claims 19-20 may include determining whether the write request satisfies the allocating write criterion based on determining whether the write request was triggered by a process running on the first processor, wherein the write request satisfies the allocating write criterion if the write request was triggered by a process running on the first processor. In example 22, the subject matter of any one of claims 19-21 may include the first processor being further configured to determine a latency associated with cache to cache transfers between the first processor and a second processor executing a process that triggered the write request, wherein determining whether the write request satisfies the allocating write criterion comprises determining whether the latency is below a latency threshold, and wherein the write request satisfies the allocating write criterion if the latency is below the latency threshold.

In example 23, the subject matter of any one of claims 19-22 may include the plurality of processors arranged in a ring configuration, wherein the first processor is further configured to determine a quantity of the plurality of processors separating the processor and an additional processor, wherein determining whether the write request satisfies the allocating write criterion comprises determining whether the quantity of the plurality of processors separating the processor and the additional processor is below a threshold, and wherein the write request satisfies the allocating write criterion if the quantity is below the threshold.

In example 24, the subject matter of any one of claims 19-23 may include determining whether the write request satisfies the allocating write criterion based on determining whether the write request includes an indicator that the write request is to be satisfied with an allocating write, wherein the write request satisfies the allocating write criterion if the indicator is detected. In example 25, the subject matter of any one of claims 19-24 may include the indicator being a set bit in the write request, wherein the I/O device sets the bit in the write request responsive to a process running on one of the first processor or a second processor sending an instruction to a driver for the I/O device that the write request is to be satisfied by the allocating write.

In example 26, an apparatus comprises means for receiving a write request from an input/output (I/O) device connected to the first processor, means for determining whether the write request satisfies an allocating write criterion, and means for writing data associated with the write request to a cache of the first processor responsive to determining that the write request satisfies the allocating write criterion. In example 27, the subject matter of example 26 may include means for writing the data associated with the write request to a memory associated with a second processor responsive to determining that the write request fails to satisfy the allocating write criterion.

In example 28, the subject matter of any one of examples 26-27 may include determining whether the write request satisfies the allocating write criterion based on determining whether the write request was triggered by a process running on the first processor, wherein the write request satisfies the allocating write criterion if the write request was triggered by a process running on the first processor.

In example 29, the subject matter of any one of examples 26-28 may include means for determining a latency associated with cache to cache transfers between the first processor and a second processor executing a process that triggered the write request, wherein determining whether the write request satisfies the allocating write criterion comprises determining whether the latency is below a latency threshold, and wherein the write request satisfies the allocating write criterion if the latency is below the latency threshold.

In example 30, the subject matter of any one of examples 26-29 may include the first processor being one of a plurality of processors arranged in a ring configuration. The apparatus in example 30 may include means for determining a quantity of the plurality of processors separating the first processor and the second processor, wherein determining whether the write request satisfies the allocating write criterion comprises determining whether the quantity of the plurality of processors separating the first processor and the second processor is below a threshold, and wherein the write request satisfies the allocating write criterion if the quantity is below the threshold.

In example 31, the subject matter of any one of examples 26-30 may include determining whether the write request satisfies the allocating write criterion based on determining whether the write request includes an indicator that the write request is to be satisfied with an allocating write, wherein the write request satisfies the allocating write criterion if the indicator is detected.

In example 32, a computer readable storage medium has instructions that, when executed by a processor, cause the processor to perform operations comprising receiving, by the processor, a write request from an input/output (I/O) device connected to the processor, determining, by the processor, whether the write request satisfies an allocating write criterion, and responsive to determining that the write request satisfies the allocating write criterion, writing data associated with the write request to a cache of the processor. In example 33, the subject matter of example 32 may further include, responsive to determining that the write request fails to satisfy the allocating write criterion, writing the data associated with the write request to a memory associated with an additional processor.

In example 34, the subject matter of any one of claims 32-33 may include determining whether the write request satisfies the allocating write criterion based on determining whether the write request was triggered by a process running on the processor, wherein the write request satisfies the allocating write criterion if the write request was triggered by a process running on the processor. In example 35, the subject matter of any one of claims 32-34 may include determining a latency associated with cache to cache transfers between the processor and an additional processor executing a process that triggered the write request, wherein determining whether the write request satisfies the allocating write criterion comprises determining whether the latency is below a latency threshold, and wherein the write request satisfies the allocating write criterion if the latency is below the latency threshold.

In example 36, the subject matter of any one of claims 32-35 may include the processor being one of a plurality of processors arranged in a ring configuration. In example 36, the computer readable storage medium may further perform operations comprising determining a quantity of the plurality of processors separating the processor and an additional processor, wherein determining whether the write request satisfies the allocating write criterion comprises determining whether the quantity of the plurality of processors separating the processor and the additional processor is below a threshold, and wherein the write request satisfies the allocating write criterion if the quantity is below the threshold.

In example 37, the subject matter of any one of claims 32-36 may include determining whether the write request satisfies the allocating write criterion based on determining whether the write request includes an indicator that the write request is to be satisfied with an allocating write, wherein the write request satisfies the allocating write criterion if the indicator is detected.

All optional features of the apparatus described above may also be implemented with respect to the method or process described herein. Specifics in the examples may be used anywhere in one or more embodiments.

While a limited number of embodiments have been described, those skilled in the art will appreciate numerous modifications and variations therefrom. It is intended that the appended claims cover all such modifications and variations as fall within the true spirit and scope of this disclosure.

1-25. (canceled)

26. A method comprising:
receiving, by a first processor, a write request from an input/output (I/O) device connected to the first processor;
determining, by the first processor, whether the write request satisfies an allocating write criterion; and
responsive to determining that the write request satisfies the allocating write criterion, writing data associated with the write request to a cache of the first processor.

27. The method of claim 26, further comprising:
responsive to determining that the write request fails to satisfy the allocating write criterion, writing the data associated with the write request to a memory associated with a second processor.

28. The method of claim 26, wherein determining whether the write request satisfies the allocating write criterion comprises determining whether the write request was triggered by a process running on the first processor, and wherein the write request satisfies the allocating write criterion if the write request was triggered by a process running on the first processor.

29. The method of claim 26, further comprising:
determining a latency associated with cache to cache transfers between the first processor and a second processor executing a process that triggered the write request;
wherein determining whether the write request satisfies the allocating write criterion comprises determining whether the latency is below a latency threshold, and wherein the write request satisfies the allocating write criterion if the latency is below the latency threshold.

30. The method of claim 26, wherein the first processor is one of a plurality of processors arranged in a ring configuration, the method further comprising:
determining a quantity of the plurality of processors separating the first processor and a second processor;
wherein determining whether the write request satisfies the allocating write criterion comprises determining whether the quantity of the plurality of processors separating the first processor and the second processor is below a threshold, and wherein the write request satisfies the allocating write criterion if the quantity is below the threshold.

31. The method of claim 26, wherein determining whether the write request satisfies the allocating write criterion comprises determining whether the write request includes an indicator that the write request is to be satisfied with an allocating write, and wherein the write request satisfies the allocating write criterion if the indicator is detected.

32. The method of claim 31, wherein the indicator is a set bit in the write request, and wherein the I/O device sets the bit in the write request responsive to a process running on one of the first processor or a second processor sending an instruction to a driver for the I/O device that the write request is to be satisfied by the allocating write.

33. A processor comprising:
a cache; and
a hybrid write mode logic coupled to the cache, wherein the hybrid write mode logic is configured to:
receive a write request from an input/output (I/O) device connected to the processor;
determine whether the write request satisfies an allocating write criterion; and
write data associated with the write request to the cache of the processor responsive to determining that the write request satisfies the allocating write criterion.

34. The processor of claim 33, wherein the hybrid write mode logic is further configured to:
write the data associated with the write request to a memory associated with an additional processor responsive to determining that the write request fails to satisfy the allocating write criterion.

35. The processor of claim 33, wherein determining whether the write request satisfies the allocating write criterion comprises determining whether the write request was triggered by a process running on the processor, and wherein the write request satisfies the allocating write criterion if the write request was triggered by a process running on the processor.

36. The processor of claim 33, wherein the hybrid write mode logic is further configured to:
determine a latency associated with cache to cache transfers between the processor and an additional processor executing a process that triggered the write request;
wherein determining whether the write request satisfies the allocating write criterion comprises determining whether the latency is below a latency threshold, and wherein the write request satisfies the allocating write criterion if the latency is below the latency threshold.

37. The processor of claim 33, wherein the processor is one of a plurality of processors arranged in a ring configuration, and wherein the hybrid write mode logic is further configured to:
determine a quantity of the plurality of processors separating the processor and an additional processor;
wherein determining whether the write request satisfies the allocating write criterion comprises determining whether the quantity of the plurality of processors separating the processor and the additional processor is below a threshold, and wherein the write request satisfies the allocating write criterion if the quantity is below the threshold.

38. The processor of claim 33, wherein determining whether the write request satisfies the allocating write criterion comprises determining whether the write request includes an indicator that the write request is to be satisfied with an allocating write, and wherein the write request satisfies the allocating write criterion if the indicator is detected.

39. The method of claim 38, wherein the indicator is a set bit in the write request, and wherein the I/O device sets the bit in the write request responsive to a process running on one of the processor or an additional processor sending an instruction to a driver for the I/O device that the write request is to be satisfied by the allocating write.

40. A computing device comprising:
an input/output (I/O) device; and
a plurality of processors interconnected via a bus, the plurality of processors comprising a first processor that is connected to the I/O device, wherein the first processor is configured to:
receive a write request from the I/O device;
determine whether the write request satisfies an allocating write criterion; and
write data associated with the write request to the cache of the processor responsive to determining that the write request satisfies the allocating write criterion.

41. The computing device of claim 40, wherein the first processor is further configured to:
write the data associated with the write request to a memory associated with a second processor responsive to determining that the write request fails to satisfy the allocating write criterion.

42. The computing device of claim 40, wherein determining whether the write request satisfies the allocating write criterion comprises determining whether the write request was triggered by a process running on the first processor, and wherein the write request satisfies the allocating write criterion if the write request was triggered by a process running on the first processor.

43. The computing device of claim 40, wherein the first processor is further configured to:
determine a latency associated with cache to cache transfers between the first processor and a second processor executing a process that triggered the write request;
wherein determining whether the write request satisfies the allocating write criterion comprises determining whether the latency is below a latency threshold, and wherein the write request satisfies the allocating write criterion if the latency is below the latency threshold.

44. The computing device of claim 40, wherein the plurality of processors are arranged in a ring configuration, and wherein the first processor is further configured to:
determine a quantity of the plurality of processors separating the processor and an additional processor;
wherein determining whether the write request satisfies the allocating write criterion comprises determining whether the quantity of the plurality of processors separating the processor and the additional processor is below a threshold, and wherein the write request satisfies the allocating write criterion if the quantity is below the threshold.

45. The computing device of claim 40, wherein determining whether the write request satisfies the allocating write criterion comprises determining whether the write request includes an indicator that the write request is to be satisfied with an allocating write, and wherein the write request satisfies the allocating write criterion if the indicator is detected.
